(19) United States
(12) Patent Application Publication
(10) Pub. No.: US 2011/0063380 A1
(43) Pub. Date: Mar. 17, 2011

(54) INK JET HEAD

(75) Inventor: Chiaki TANUMA, Tokyo (JP)

(73) Assignee: TOSHIBA TEC KABUSHIKI KAISHA, Tokyo (JP)

(21) Appl. No.: 12/869,485

(22) Filed: Aug. 26, 2010

(30) Foreign Application Priority Data
Sep. 16, 2009 (JP) 2009-214972

(51) Int. Cl. B41J 2/175

(52) U.S. Cl. 347/85

(57) ABSTRACT

According to one embodiment, an ink jet head includes a base portion and a plurality of nozzles configured to discharge ink formed in one end side of the base portion, an actuator including a plurality of pressure chambers corresponding to the plurality of nozzles, is provided on a first surface which is an end surface of the one end side of the base portion, ink guides which form ink channels are formed on a second surface which is a main surface of the base portion and crosses with the first surface, and a wiring connected to the actuator is formed on a third surface which is another main surface opposite to the second surface of the base portion.

### CROSS-REFERENCE TO RELATED APPLICATIONS

This application is based upon and claims the benefit of priority from Japanese Patent Application No. 2009-214972, filed on Sep. 16, 2009; the entire contents of which are incorporated herein by reference.

### FIELD

Embodiments described herein relate generally to an ink jet head including an ink-discharging nozzle.

### BACKGROUND

With regard to circulation-type ink jet heads, such a structure is known, which comprises a nozzle plate including a plurality of nozzles, a plurality of pressure chambers provided to correspond respectively to the nozzles, on a main surface of a plate-shaped substrate, a base substrate in which ink channels and liquid chambers communicating to the pressure chambers are built, and a printed circuit board on which wiring which drives the pressure chambers are formed.

In such an ink jet head, grooves are formed by mechanical processing in a piezoelectric member provided on the main surface of the plate-shaped base substrate.

However, the above-described technique entails the following problem. That is, a plate-shaped piezoelectric member has a low stiffness in its thickness direction and the piezoelectric member in many cases deforms while being subjected to mechanical processing on its main surface, which applies a load on the member in its thickness direction. Due to this drawback, it is difficult to form the pressure chambers at a high accuracy.

### BRIEF DESCRIPTION OF THE DRAWINGS

FIG. 1 is a perspective view showing an ink jet head according to the first embodiment;

FIG. 2 is an exploded perspective view showing a base structure portion of the ink jet head according to the first embodiment;

FIG. 3 is an enlarged perspective view showing a portion A shown in FIG. 2;

FIG. 4 is an enlarged side view showing a portion B shown in FIG. 3;

FIG. 5 is a plan view showing the base structure portion of the ink jet head according to the first embodiment; and

FIG. 6 is a side view showing the ink jet head according to the first embodiment.

### DETAILED DESCRIPTION

### The First Embodiment

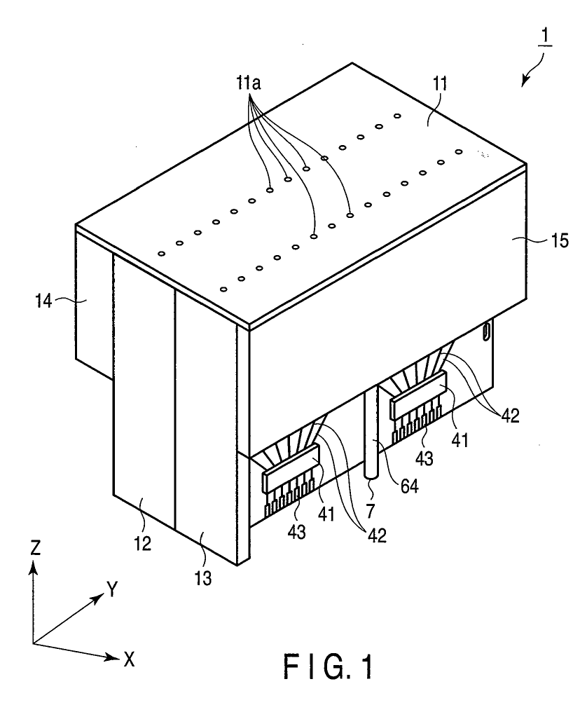

In general, according to one embodiment, an ink jet head 1 according to the first embodiment will now be described with reference to FIGS. 1 to 6. In these figures, arrows X, Y and Z indicate 3 directions normally crossing with each other. Further, in these figures, structures are enlarged, contracted or omitted as need for the sake of explanation.

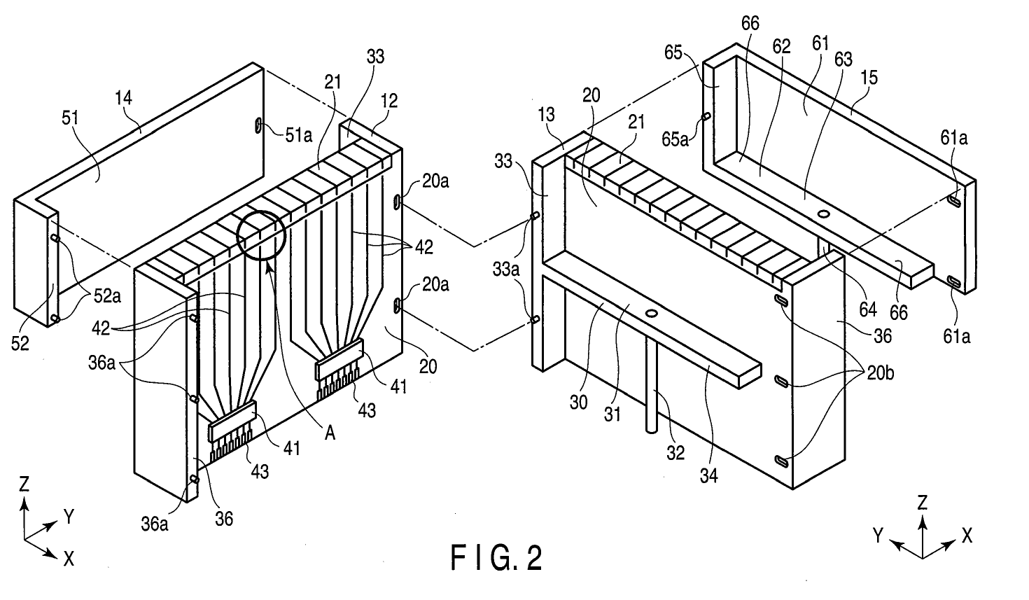

FIG. 1 is a perspective view showing the ink jet head 1 according to the first embodiment. FIG. 2 is an exploded perspective view showing a structural portion of the ink jet head 1 of this embodiment, while partially omitting the structural portion. In these figures, the head is inverted upside down such that nozzles 11a are arranged upwards and the ink discharging direction faces upwards for the convenience of explanation.

In FIG. 2, a set of a first actuator unit 12 and a first cover 14 and a set of a second actuator unit 13 and a second cover 15 are shown to be developed while these sets are rotated by 90 degrees with respect to each other. A pair of the actuator units 12 and 13 have the same structure and therefore common explanations will not be repeated. In FIG. 2, a rear side (one side in the X direction) of the first actuator unit 12 and a front side (the other side in the X direction) of the second actuator unit 13 are shown.

The ink jet head 1 of this embodiment is the so-called circulation type ink jet head in which ink is circulated at all times. As shown in FIGS. 1 and 2, the ink jet head 1 comprises a nozzle plate 11 in which a plurality of nozzles 11a are formed, A pair of the actuator units 12 and 13 arranged to face each other on a lower surface side of the nozzle plate 11, and a pair of covers 14 and 15 formed to cover both sides of the pair of these actuator units 12 and 13.

The nozzle plate 11 is formed into a plate shape comprising a plurality of nozzles 11a respectively corresponding to a plurality of pressure chambers 23. The nozzle plate 11 is provided to cover a base structure portion 10 from an upper side, which comprises the pair of the actuator units 12 and 13 and the pair of the covers 14 and 15.

Each of the actuator units 12 and 13 comprises a base portion 20 of a rectangular parallelepiped shape having upper and lower surfaces normally crossing the Z axis, front and rear surfaces normally crossing the X axis and both side surfaces normally crossing the Y axis. The base portion 20 is formed of a material selected from, for example, a metal, ceramics and resin, and is placed in such a manner that its thickness direction goes along the X-axis, its longitudinal direction along the Y-axis, and its width direction along the Z-axis. For example, the base portion 20 is formed to have such dimensions of several tens of millimeters in width, 18 mm in thickness and about 60 mm in length.

A piezoelectric actuator 21 is formed via an adhesive layer 27 on an upper surface (first surface) of the base portion 20, which is an end face close to the nozzle 11a.

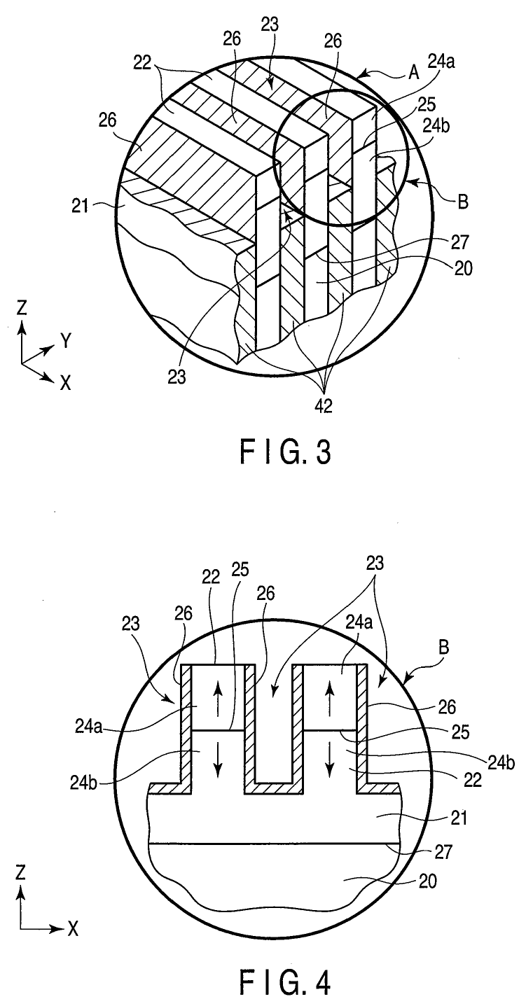

As shown in FIGS. 3 and 4 enlarged, the piezoelectric actuator 21 (actuator) comprises a plurality of driver elements 22 arranged in the Y direction. Each portion sandwiched from both sides by a respective adjacent pair of driver elements 22 forms a respective pressure chamber 23 corresponding to a respective nozzle 11a. In other words, driver elements 22 which drive each nozzle 11a to discharge ink are arranged both sides of each pressure chamber 23. Ink is reserved inside each of the pressure chambers 23.

Each of the driver elements 22 comprises two piezoelectric elements 24a and 24b formed of, for example, a PZT-based piezoelectric ceramic material. Each of the driver elements 22 comprises the first piezoelectric element 24a at a position close to the nozzle 11a and the second piezoelectric element 24b at a position distant from the nozzle 11a. The first piezoelectric element 24a and the second piezoelectric element 24b are subjected to a polarization process such that the polarization directions of the elements are reverse to each other, and they are adhered to each other via an adhesive layer 25. An electrode 26 is formed on an inner surface of each pressure chamber 23 formed between an adjacent pair of driver elements 22.

As shown in FIG. 2, an ink guide 30 is formed in a surface (the second surface) of the base portion 20. The ink guide 30 comprises a T-shaped guide rib 31 which stands from the second surface in the X direction, and a cylindrical guide pipe 32 which extends from the Y-axial central portion of the guide rib 31 downwards, which are integrated as one unit.

The guide rib 31 is formed as integrated with the base portion 20 by, for example, molding when forming the base portion 20. The guide rib 31 comprises an outer rib 33 formed along the longitudinal edge of the base portion 20 to each both the upper and lower ends, and an inner rib 34 which extends in the Y direction at the Z-axial central portion of the base portion 20. On an distal end surface of the outer rib 33, a plurality of alignment projections 33a are formed.

The guide pipe 32 are continuously formed from the central position of the inner rib 34 downwards, and an ink channel is formed within the guide pipe 34 from a common liquid chamber formed on an upper side of the guide rib 31 to reach below the ink jet head 1.

A plurality of driver ICs 41 which drive the operation of the piezoelectric actuator 21 and a plurality of wirings 42 (electrodes) which connect the driver ICs 41 and the electrode 26 to each other are formed on the rear surface (third surface) of the base portion 20. That is, the rear surface of the base portion 20 functions as a printed circuit board. The wirings 42 are formed to respectively correspond to the driver elements 22 by a one-to-one manner. Further, the rear surface comprises electric connection portions 43 formed continuous to the wirings 42, respectively.

It should be noted that the wirings 42, the driver ICs 41 and the electric connection portions 43 are arranged at positions which detour the opposing ink guide 30.

A plurality of alignment recess portions 20a are formed on a Y-axial one end side of the rear surface of the base portion 20.

Further, at the edge of the Y-axial other end side of the rear surface of the base portion 20, an outer rib 36 is formed to stand up in the X direction. The outer rib 36 is formed to reach both the upper and lower ends of the base portion 20, and a plurality of alignment projections 36a are formed on the distal end surface thereof.

The first cover 14 is provided on the front surface side of the first actuator unit 12, and is formed into an L-shape in its plan view to comprise a plate portion 51 which covers the surface of the first actuator unit 12 while interposing the liquid chambers and ink channels, and an outer rib 52 which stand up from the edge of the Y-axial other end side of the plate portion 51. A alignment recess portion 51a is formed in the edge of the Y-axial one end side of the plate portion 51. The outer rib 52 is formed to bent from the plate portion 51 in the X direction and stand towards the first actuator unit 12. When the outer rib 52 is assembled onto the actuator unit 12, a liquid chamber is formed. A plurality of alignment projections 52a are formed on the outer rib 52.

The second cover 15 is provided on the rear surface side of the second actuator unit 13, and is formed to comprise a plate portion 61 which covers the rear surface of the second actuator unit 13 while interposing the liquid chambers and ink channels, and an ink guide 62 formed on the inner surface of the plate portion 61. Alignment recess portion 61a are formed in the edge of the Y-axial other end side of the plate portion 61.

An ink guide 62 is formed comprises an L-shaped guide rib 63 which stands from the inner surface in the X direction, and a cylindrical guide pipe 64 which extends from the Y-axial central portion of the guide rib 63 downwards, which are integrated as one unit. With this structure, liquid chambers and ink channels are formed. The guide rib 63 comprises an outer rib 65 formed along with the edge of the Y-axial one end side of the second cover 15 to reach the upper end from the center, and an inner rib 66 which extends in the Y direction at the Z-axial central portion of the second cover 15. The guide rib 63 is formed as integrated with the second cover 15 by, for example, molding when forming the base portion 20. On the outer rib 65, a plurality of alignment projections 65a are formed.

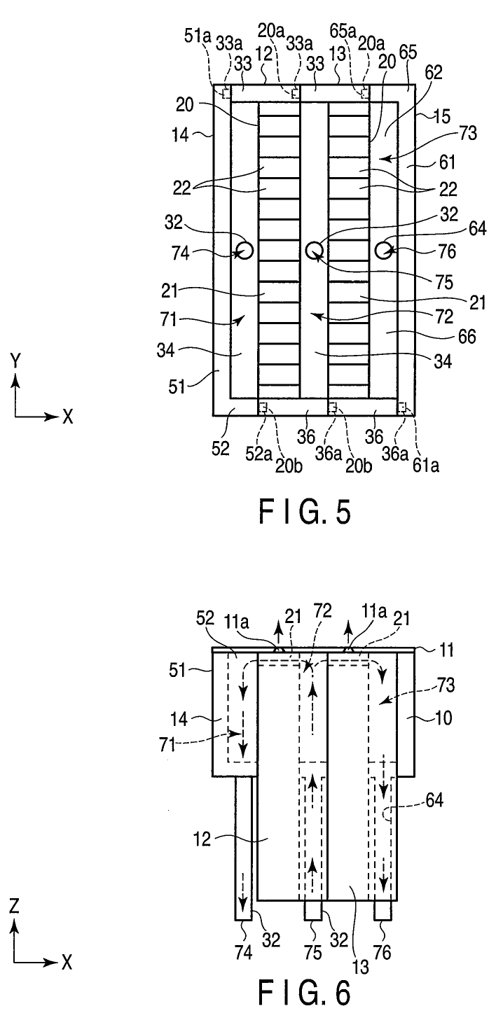

The first and second actuator units 12 and 13 and the first and second covers 14 and 15 are combined together to form the base structural portion 10. During this assembling, the alignment projections 33a, 52a, 36a and 65a are inserted to the alignment recess portions 51a, 20a, 20b and 61a, respectively, as shown in FIGS. 2 and 5, how they engage with each other, and thus these members are aligned with each other.

As shown in FIGS. 1, 5 and 6, in the base structural portion 10 in the assembled state, as the distal end surface of each of the outer ribs 33, 36, 52 and 65 and the inner ribs 34 and 66 abuts against the surface of the opposing member, 3 liquid chambers 71 to 73 which are partitioned by a pair of base portions 20 are formed in the upper half portion of the base structural portion 10. In other words, the plate-like outer ribs 33, 36, 52 and 65 formed on both of the Y-axial ends form side portions of the liquid chambers 71 to 73, and the plate-like inner ribs 34 and 66 which extend in the Y direction at the z-axial central portion form bottom portions of the liquid chambers 71 to 73.

Further, the guide pipes 32, 32 and 64 which respectively extend from the 3 inner ribs 34, 34 and 66 from their center portions form the ink channels communicating with the liquid chambers 71 to 73. The guide pipe 32 formed in the first actuator unit 12 gives rise to an ink outlet 74, and the guide pipe 32 formed in the second actuator unit 13 gives rise to an ink inlet 75. The guide pipe 64 formed in the second cover 15 gives rise to an ink outlet 76.

The manufacturing process for the ink jet head 1 according to this embodiment will now be described. First, the base portions 20 and the covers 14 and 15 are formed, and these members are assembled together to form the base structural portion 10. The base portions 20 and the covers 14 and 15 are each formed of a material selected from, for example, a metal, ceramics or resin, into a respective predetermined shape. For example, when the base portions 20 are made of a resin by molding, the outer ribs 33 and 36 and the inner rib 34 as well as the cylindrical guide pipe 32 are formed as an integral unit. Or, when they are formed of a metal, the cylindrical guide pipe 32 may be formed as a separate unit, and then mounted to the inner rib 34.

Next, the wirings 42 are formed on the rear surface of each of the base portions 20, and the driver ICs 41 and the electric connection portions 43 are mounted thereon.

In order to form a plurality of pressure chambers 23 in the piezoelectric actuator 21, a piezoelectric material is fixed to the end surface of the base portion 20 by means of the adhesive layer 27, and then the resultant is subjected to mechanical processing to form grooves in the piezoelectric material. During this process, a load is applied to the base portion 20 in its width direction, but the dimension of the base portion 20 in the width direction is relatively larger, thereby making it possible to prevent the base portion from deforming.

The first and second actuator units 12 and 13 and the first and second covers 14 and 15 are combined while aligning with each other, and thus the base structural portion 10 is formed. Further, the nozzle plate 11 is attached thereto such as to cover the liquid chambers 71 to 73 opened in the base structural portion 10. Thus, the assembling of the ink jet head 1 is completed.

The operation of the ink jet head 1 will now be described. As indicated by arrows in FIG. 6, the ink supplied to the liquid chamber 72 from the ink inlet 75 is transferred into the pressure chamber 23. In the pressure chamber 23, the ink pressurized by the driver element 22 is discharged as ink drops from the nozzles 11a. The portion of the ink which was not used as ink drops is discarded to the outside of the liquid chambers 71 and 73 from the ink outlets 74 and 76.

In order to discharge ink drops from the nozzles 11a, a drive voltage is applied to the driver elements via the wirings 42 by the driver circuits. When an electric current flows to the first piezoelectric element 24a and the second piezoelectric element 24b of the driver element 22, the first piezoelectric element 24a and the second piezoelectric element 24b shown in FIG. 4 are bent in opposite directions from each other. As both of the piezoelectric elements 24a and 24b are bent, the driver element 22 is bent by deformation into an L-shape, thereby making the adjacent pressure chamber 23 smaller in volume. As the pressure chamber 23 is made smaller in volume, the pressure of the ink in the pressure chamber 23 is made higher, and thus ink drops are discharged vigorously from the nozzles 11a.

According to the ink jet head 1 of this embodiment, the following advantages are exhibited. That is, with the structure that the piezoelectric actuator 21 provided on the end surface of the base portion 20, the base portion 20 is not easily deformed even when a load is applied thereto by the mechanical processing carried out for the formation of the pressure chambers 23. For this reason, a plurality of pressure chambers 23 can be formed easily at a high precision. Further, the guide rib 31 which stands up on the base portion 20 are formed as an integral unit, and thus the stiffness of the base portion 20 in its thickness direction can be enhanced.

A plurality of members 12, 13, 14 and 15 are combined together, and thus the liquid chambers 71 to 73 are formed between the members by means of the outer ribs 33, 36 and 65 and the inner ribs 34 and 66 formed to be integrated with the members 12, 13, 14 and 15. With this design, the structures of the members are simplified, and the manufacturing process is facilitated.

Moreover, the piezoelectric actuator 21 is provided on the end surface of the base portion 20, the ink guide 30 is formed on the front surface and the wirings 42 are formed on the rear surface. With this structure, a plurality of functions can be separated, thereby making it possible to increase the flexibility in designing. For example, in the case where holes for the ink channels are made in the same surface as that of the wirings, the wirings must be set to detour the ink channels. By contrast, with the structure of the above-described embodiment, the formation of the wirings 42 is not so restricted, and therefore it is easy to finely form the pattern of the wirings 42 and adjust the lengths of the wirings 42. Therefore, the lengths of the wirings 42 connected to the respective pressure chambers 23 can be made even, thereby making it possible to make the resistances of the wirings 42 uniform.

It should be noted that the present invention, when carried out in practise, is not limited directly to the above-described embodiment, but it can be realized while remodifying the structural elements thereof within the scope where the essence of the invention remains. Further, various types of invention can be achieved by combining or rearranging various structural elements disclosed in the embodiment appropriately. For example, some of the structural elements may be deleted from the entire structure disclosed in the embodiment. Further, structural elements of various versions may be combined together as needed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An ink jet head comprising:
a base portion further comprising a plurality of nozzles configured to discharge ink formed in one end side of the base portion;
an actuator further comprising a plurality of pressure chambers corresponding to the plurality of nozzles, on a first surface which is an end surface of the one end side of the base portion;
ink guides which form ink channels, on a second surface which is a main surface of the base portion and crosses with the first surface; and
an electrode connected to the actuator, on a third surface which is another main surface opposite to the second surface of the base portion.

2. The ink jet head according to claim 1, comprising a pair of the base portions, wherein as the third surface of one of the base portions and the second surface of the other base portion are set to face each other and the pair of the base portions are combined together, the ink channels are formed while interposing the ink guides between the second surface and the third surface.

3. The ink jet head according to claim 2, further comprising:
a first cover provided on the second surface side of the one of the base portions, which covers second surface while interposing the ink channels between the first cover itself and the second surface; and
a second cover provided on the third surface side of the other base portion, which covers third surface while interposing the ink channels between the second cover itself and the third surface, the ink guides which form the ink channels being form on an inner surface of the second cover.

4. The ink jet head according to claim 2, wherein the ink guides each further comprises: a guide rib which arises towards an opposing member and forms a liquid chamber; and a guide pipe formed continuous to the guide rib and forms an ink channel communicating with the liquid chamber.

5. The ink jet head according to claim 2, further comprising: a rib which arises towards an opposing member and forms a liquid chamber, on the third surface of the base portion and an edge of an inner surface of the second cover.

6. The ink jet head according to claim 1, wherein the base portion is formed of a material selected from the group consisting of a metal, ceramics, and a resin.
